(19) United States
(12) Patent Application Publication
(10) Pub. No.: US 2026/0039759 A1
(43) Pub. Date: Feb. 5, 2026

(54) IMAGE PROCESSING DEVICE, IMAGE READING DEVICE, IMAGE FORMING APPARATUS, BIOLOGICAL IMAGING APPARATUS, AND IMAGE PROCESSING METHOD

(71) Applicants: Takuhei YOKOYAMA, Kanagawa (JP); Ayumu HASHIMOTO, Kanagawa (JP)

(72) Inventors: Takuhei YOKOYAMA, Kanagawa (JP); Ayumu HASHIMOTO, Kanagawa (JP)

(73) Assignee: Ricoh Company, Ltd., Tokyo (JP)

(21) Appl. No.: 19/268,058

(22) Filed: Jul. 14, 2025

(30) Foreign Application Priority Data
Aug. 2, 2024 (JP) 2024-127295

(51) Int. Cl. H04N 1/00; G03G 15/22

(52) U.S. Cl. CPC H04N 1/0087; G03G 15/228; H04N 1/00822

(57) ABSTRACT

An image processing device includes circuitry configured to receive a first visible and an invisible image, remove the invisible component from the first visible image based on the invisible image to generate a second visible image, determine whether to remove the invisible component from the first visible image, and output either the first visible image based on a determination not to remove the invisible component or output the second visible image based on a determination to remove the invisible component. The first visible image is captured by a first sensor having a first sensitivity to both of first light in a visible wavelength range; and second light in an invisible wavelength range. The first visible image includes an invisible component in the invisible wavelength range. The invisible image is captured by a second sensor having a second sensitivity to the second light.

### CROSS-REFERENCE TO RELATED APPLICATIONS

This patent application is based on and claims priority pursuant to 35 U.S.C. § 119(a) to Japanese Patent Application No. 2024-127295, filed on Aug. 2, 2024, in the Japan Patent Office, the entire disclosure of which is hereby incorporated by reference herein.

### BACKGROUND

### Technical Field

The present disclosure relates to an image processing device, an image reading device, an image forming apparatus, a biological imaging apparatus, and an image processing method.

### Related Art

A technology has been proposed that enhances document security by imbedding invisible information in a document, which can be read using an image reading device with invisible light to verify the authenticity of the document.

### SUMMARY

An embodiment of the present disclosure provides an image processing device includes circuitry configured to receive a first visible and an invisible image, remove the invisible component from the first visible image based on the invisible image to generate a second visible image, determine whether to remove the invisible component from the first visible image, and output either the first visible image based on a determination not to remove the invisible component or output the second visible image based on a determination to remove the invisible component. The first visible image is captured by a first sensor having a first sensitivity to both of first light in a visible wavelength range; and second light in an invisible wavelength range. The first light and the second light are reflected from an object to be read, and the first visible image includes an invisible component in the invisible wavelength range. The invisible image is captured by a second sensor having a second sensitivity to the second light.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a side view of an image reading device according to a first embodiment;

FIG. 2 is a block diagram of a configuration of the image reading device in FIG. 1;

FIG. 3 is a block diagram of a functional configuration of a processor incorporated in the image reading device in FIG. 1;

FIG. 4 is a diagram of the spectral characteristics of the output from a light source;

FIGS. 5A and 5B are diagrams each representing spectral sensitivity characteristics of an image sensor;

FIG. 6 is a diagram representing the spectral characteristics of the output from an R sensor;

FIG. 7 is a diagram showing an example of pixel values of a visible image from which invisible components have been removed.

FIGS. 8A, 8B, and 8C are diagrams illustrating examples of noise in pixel values before and after invisible components are removed.

FIG. 9 is a flowchart illustrating an example of a processing procedure of a processing unit according to the present exemplary embodiment of the first exemplary embodiment;

FIG. 10 is a block diagram of a configuration of an image reading device according to a second embodiment;

FIG. 11 is a block diagram of a functional configuration of a processor incorporated in the image reading device in FIG. 10;

FIG. 12 is a diagram illustrating an example of a functional configuration of a processing unit according to a third embodiment;

FIG. 13 is a diagram illustrating an example of a functional configuration of a processing unit according to a fourth embodiment;

FIG. 14 is a block diagram showing an example of the configuration of an image reading device according to a fifth embodiment;

FIG. 15 is a cross-sectional view illustrating a configuration of a mechanical section of an image forming apparatus according to a sixth embodiment;

FIG. 16 is a diagram of a configuration of a biological imaging apparatus according to a seventh embodiment; and

FIGS. 17A, 17B, and 17C are diagrams illustrating application examples of biological imaging according to a seventh embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a typical technology, the image reading device is equipped with a visible light sensor and an invisible light sensor, and simultaneously emits both visible light and invisible light onto a document and captures both a visible image and an invisible image at the same time. However, since a visible light sensor typically has sensitivity to an invisible wavelength range, a visible image includes a component in the invisible wavelength range (i.e., an invisible component), causing a lower color reproducibility. To address this, a technique has been developed to remove invisible components from visible images using invisible images. However, it is known that uniformly removing these components can degrade image quality, as the invisible images contain noise.

A technology is also proposed to determine whether to perform calculation for removing an invisible component, depending on whether the valid signal level is valid or not.

However, the proposed technology does not determine the valid signal level based on whether the removal of an invisible component is necessary. As a result, removing the invisible component even when unnecessary can degrade image quality due to noise contained in the invisible image.

According to one aspect of the present disclosure, by determining whether an invisible component is to be removed, image quality degradation due to noise contained in the invisible image can be prevented.

In the following description, embodiments of an image processing device, an image reading device, an image forming apparatus, a biological imaging apparatus, and an image processing method are described in detail with reference to the accompanying drawings.

### First Embodiment

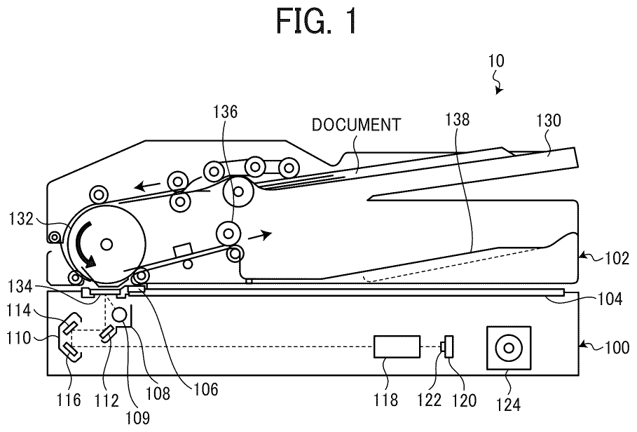

FIG. 1 is a side view of an image reading device 10 according to a first embodiment. The image reading device 10 is a sheet-through type. The image reading device 10 includes a reading unit body 100 (e.g., a flatbed scanner) and an automatic document feeder (ADF).

The reading unit body 100 includes a contact glass 104, a reference white plate 106, a first carriage 108, a second carriage 110, a lens 118, a photodetector array 122 mounted on a photodetector substrate 120, and a scanner motor 124. The first carriage 108 includes a light source 109 and a mirror 112. The second carriage 110 includes mirrors 114 and 116. The reading unit body 100 includes a reading window 134 through which a document fed by the ADF 102 is read.

The ADF 102 is mounted on the upper portion of the reading unit body 100, and automatically feeds and conveys a document. The ADF 102 includes a document tray 130, a conveyance drum 132, a sheet discharge roller 136, and a sheet discharge tray 138. The ADF 102 conveys the document placed on the document tray 130 toward the conveyance drum 132, and the conveyance drum 132 conveys the document toward the reading window 134. The document is exposed to light from the light source 109 as it passes over the reading window 134. The light reflected from the document is successively reflected by the mirror 112 of the first carriage 108 and the mirrors 114 and 116 of the second carriage 110, and then passes through the lens 118 to form a reduced image on the light-receiving surface of the photodetector array 122 on the photodetector substrate 120.

In flatbed reading, where a document is fixed on the contact glass 104 and scanned by the first carriage 108 and the second carriage 110, light from the light source 109 illuminates the document from below the contact glass 104. The first carriage 108 and the second carriage 110 are collectively referred to as the carriage. The light reflected from the document is successively reflected by the mirror 112 of the first carriage 108 and the mirrors 114 and 116 of the second carriage 110, and then passes through the lens 118 to form a reduced image on the light-receiving surface of the photodetector array 122 on the photodetector substrate 120. During this process, the image reading device 10 scans the entire document by moving the first carriage 108 at a speed V in a sub-scanning direction of the document, while moving the second carriage 110 in coordination with the first carriage 108 at a speed of ½V, which is half of the speed V.

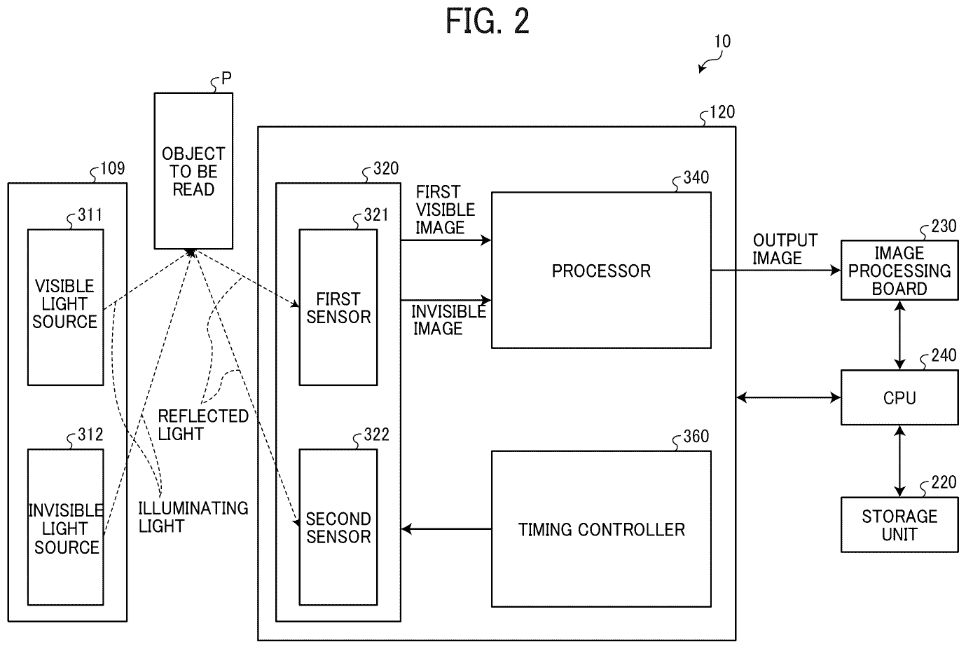

The following describes in detail the configuration of the image reading device 10 illustrated in FIG. 1. FIG. 2 is a block diagram of the configuration of the image reading device 10 in FIG. 1. The image reading device 10 includes a light source 109, a photodetector substrate 120, a storage unit 220, an image processing board 230, and a central processing unit (CPU) 240.

The light source 109 is, for example, a light emitting diode (LED) array, and includes a visible light source 311 and an invisible light source 312. The invisible light source 312 is, for example, an infrared light source. The light source 109 illuminates an object P to be read, such as a document, and light reflected from the object P is imaged onto a sensor 320 of the photodetector substrate 120 by an optical system including the mirrors 112, 114, and 116, and the lens 118 described above. The photodetector substrate 120 photoelectrically converts the reflected light that has been imaged into image data, and outputs the image data. The storage unit 220 includes a hard disk drive (HDD) or a memory. The image processing board 230 performs various types of image processing on the output image data. The CPU 240 controls the respective units of the image reading device 10.

The photodetector substrate 120 includes the sensor 320, a processor 340, and a timing controller 360. The sensor 320 is, for example, a complementary metal oxide semiconductor (CMOS), and includes a first sensor 321 and a second sensor 322.

The first sensor 321 has sensitivity to both a wavelength range (i.e., a visible wavelength range) of the visible light source 311 and a wavelength range (i.e., an invisible wavelength range) of the invisible light source 312. The second sensor 322 has sensitivity to the invisible wavelength range.

The processor 340 generates an output image using a first visible image and an invisible image, which are obtained by reading the object P with the first sensor 321 and the second sensor 322, respectively.

The processor 340 is an example of an image processing device that processes the first visible image and the invisible image. The image reading device 10 includes an image processing device (e.g., the processor 340), the first sensor 321, and the second sensor 322.

The timing controller 360 sets drive cycles for the operations of the respective units in the photodetector substrate 120, and generates, for example, a clock (CLK) and a line synchronization signal (SYNC).

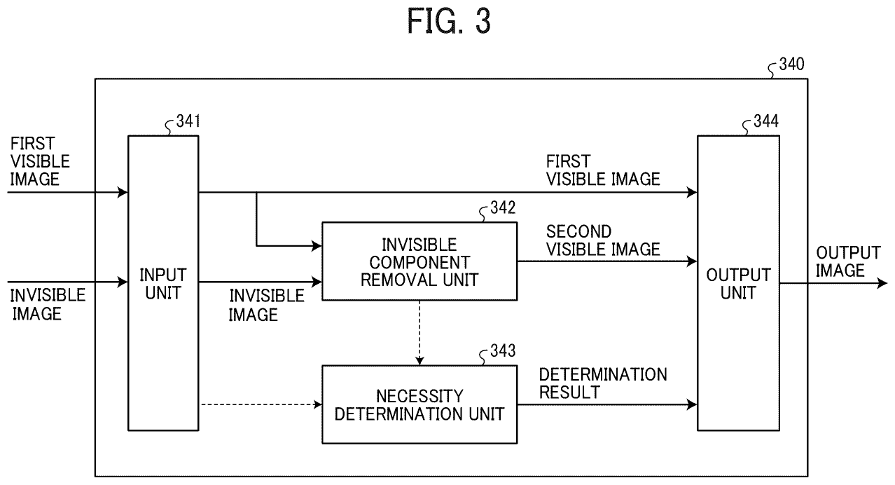

FIG. 3 is a block diagram of a functional configuration of the processor 340 included in the image reading device 10 as illustrated in FIGS. 1 and 2. As illustrated in FIG. 3, the processor 340 of the image reading device 10 includes an input unit 341, an invisible component removal unit 342, a necessity determining unit 343, and an output unit 344.

The input unit 341 receives the first visible image and the invisible image from the sensor 320. The invisible component removal unit 342 generates a second visible image by removing, from the first visible image, an invisible component corresponding to the invisible wavelength range, using the first visible image and the invisible image.

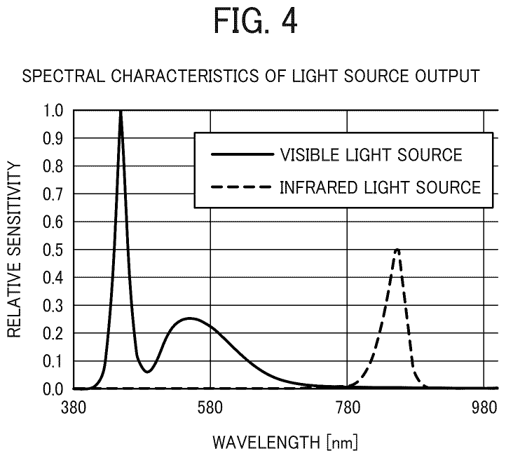

The following describes the spectral characteristics of the output from the first sensor 321, with reference to FIGS. 4 to 6. FIG. 4 is a diagram of the spectral characteristics of the output from a light source. In FIG. 4, a solid line indicates a spectral characteristic of output from the visible light source 311, and a broken line indicates a spectral characteristic of output from the infrared light source as one example of the invisible light source 312. These spectral characteristics are illustrated in terms of relative sensitivity.

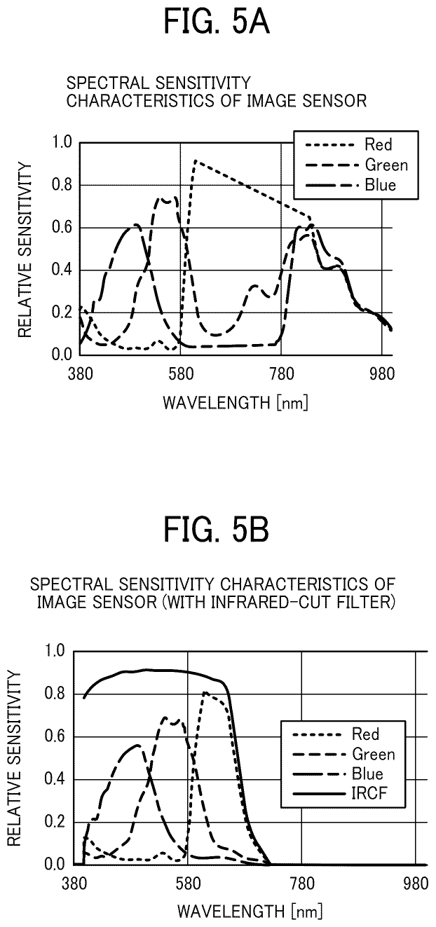

FIG. 5A is a diagram representing spectral sensitivity characteristics of an image sensor. The first sensor 321 includes three color sensors (or line image sensors), which are a red (R) sensor, a green (G) sensor, and a blue (B) sensor. An R filter, a G filter, and a B filter are respectively stacked on the red sensor, the green sensor, and the blue sensor. Thus, the color sensors have relative sensitivities as represented in FIG. 5A. As described above, the first sensor 321 is sensitive not only to the visible wavelengths but also to invisible wavelengths equal to or greater than 700 nm.

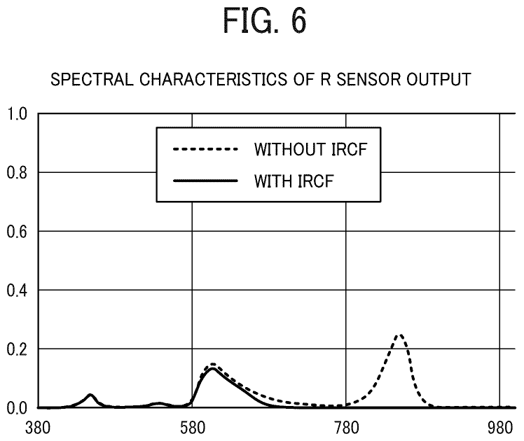

FIG. 5B represents the spectral characteristics with an infrared cut filter (IRCF). The solid line in FIG. 5B indicates the filter characteristics of the IRCF. FIG. 6 is a diagram representing the spectral characteristics of the output from an R sensor. When the reflected light beams originating from two light sources are received by the image sensors having the sensitivities as in FIGS. 5A and 5B, sensor outputs as illustrated in FIG. 6 are obtained. In this example, the spectral characteristics of the output from an R sensor are presented. Further, it is assumed that the spectral characteristics of the reflectance, i.e., spectral reflectance, of the object P are uniform over all wavelengths.

Since the sensor output is the product of the light source output and the sensor sensitivity, an invisible component appears when no IRCF is used, as indicated by the broken line in FIG. 6. The invisible component is an unnecessary component that does not contribute to visual recognition. Including the invisible component in the formation of a visible image reduces color reproducibility. To avoid such a situation, one approach is to include an IRCF in the image sensor, and another approach is to add a function that removes invisible components. When the IRCF is included in the image sensor, a sensor output in which the invisible component is removed is obtained, as indicated by the solid line in FIG. 6. However, the spectral cutoff characteristics of the IRCF are typically not sharp, and the invisible component may not be removed as intended. In the present embodiment, an invisible component removal unit 342 having a function of removing an invisible component is included to obtain a second visible image in which an invisible component is removed.

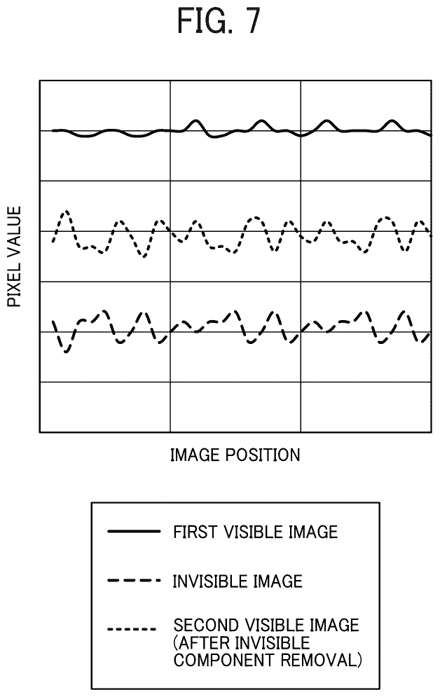

FIG. 7 is a diagram representing pixel values of a visible image in which an invisible component is removed. In FIG. 7, a solid line indicates the first visible image, a broken line indicates the invisible image, and a dotted line indicates the second visible image. In this example, it is assumed that the spectral reflectance of the object P is uniform over all reading positions. In addition, the invisible image is subtracted from the first visible image at each pixel position to remove the invisible component.

Even if the spectral reflectance is uniform regardless of the reading position, the light emitted from the light source 109 includes random noise (i.e., optical shot noise). Accordingly, noise occurs in the pixel values of the first visible image and the invisible image, as illustrated in FIG. 7. Further, since the first visible image and the invisible image are read by different sensors, and since the photoelectric conversion noise and the sensor-inherent noise differ between the sensors, different noise appears in the first visible image and the invisible image. As such, subtracting the invisible image from the first visible image to remove an invisible component causes the noise in the invisible image to be superimposed onto the first visible image, resulting in greater noise in the second visible image than in the first visible image. The influence of the noise increases as the pixel value of the first visible image decreases.

FIG. 7 illustrates an example in which the invisible image is subtracted from the visible image. Even when another method is used, such as subtracting the invisible image with weighting, any method that removes the invisible component using the invisible image unavoidably causes image quality deterioration. This is because the noise in the first visible image and the noise in the invisible image differ, as described above.

In the present embodiment, the necessity determination unit 343 determines whether an invisible component is to be removed, and outputs the determination result. The necessity determination unit 343 performs the necessity determination using various types of information. For example, the necessity determination unit 343 determines whether an invisible component is to be removed from the first visible image using information on an image reading mode and information on the first visible image and the second visible image.

Based on the determination result, the output unit 344 outputs the second visible image as an output image when it is determined that the invisible component is to be removed, and outputs the first visible image as an output image when it is determined that the invisible component is not to be removed.

The necessity determination unit 343 may input the determination result to the invisible component removal unit 342. The invisible component removal unit 342 may output either the first visible image or the second visible image based on the determination result. In this case, the output unit 344 is not used. The invisible component removal unit 342 calculates and outputs the second visible image when it is determined that the invisible component is to be removed. On the other hand, when it is determined that the invisible component is not to be removed, the invisible component removal unit 342 outputs the input first visible image without calculating the second visible image.

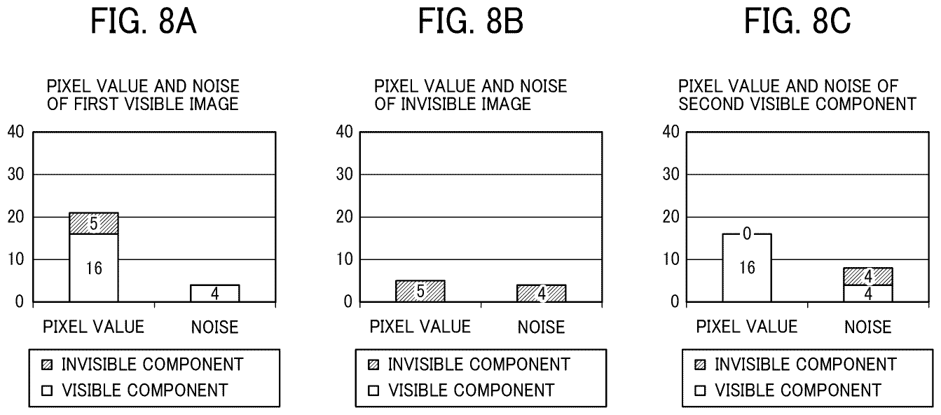

FIGS. 8A, 8B, and 8C are diagrams illustrating examples of noise in pixel values before and after invisible components are removed. FIG. 8A illustrates the absolute values of the pixel value and noise of a pixel in the first visible image, before removal of the invisible component, for both the visible component and the invisible component. Similarly, FIG. 8B illustrates the absolute values of the pixel value and noise of the invisible image, and FIG. 8C illustrates the absolute values of the pixel value and noise of a pixel in the second visible image after removal of the invisible component, for both the visible component and the invisible component. The visible component of the invisible image is 0. The pixel value in FIG. 8A includes the contribution (5) of the invisible component in addition to the contribution (16) of the visible component. The noise includes the contribution (4) of the visible component. When the invisible component removal unit 342 removes the contribution (5) of the invisible component from the pixel based on the pixel value of the invisible image, the contribution of the invisible component in the pixel value becomes zero, as illustrated in FIG. 8C. With respect to noise, the contribution (4) of the invisible component is added to the contribution (4) of the visible component due to the influence of the invisible component removal, resulting in an increase in noise.

When the noise increases in this way, for example, in a read image of a monochrome document such as a black-filled figure or a dark image, granular noise becomes conspicuous and the image quality deteriorates. In FIG. 8A, a pixel value increases by the contribution of an invisible component, but the change in color due to the contribution of the invisible components is small in the reading of a monochrome document. In addition, since a black figure or a dark image has a low reflectance with respect to invisible light, deterioration in image quality is not noticeable.

In view of this, the necessity determination unit 343 determines whether an object P is a document for which color reproducibility is not to be considered or involved, such as a monochrome document, using information on an image reading mode and information on the first visible image and the second visible image. The necessity determination unit 343 determines that the invisible component is to be removed, based on a determination that the object P is a document for which color reproducibility is not involved, such as a monochrome document.

A method for determining whether an invisible component is to be removed may be different from this. For example, even if an object P is a document with color, it may be determined that color reproducibility is not involved when the saturation of the document is less than or equal to a predetermined threshold. In this case, it may further be determined that the invisible component is not to be removed. In the present disclosure, the predetermined threshold value is, for example, a value that has been set in advance in a production facility based on experimental results.

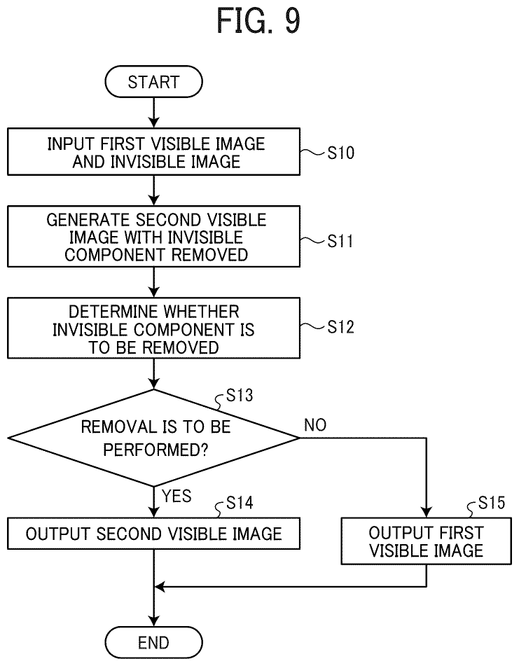

FIG. 9 is a flowchart illustrating a processing procedure of the processor 340 according to the present embodiment. In step S10, the input unit 341 receives the first visible image and the invisible image. In other words, the first visible image and the visible image are input to the processor 340.

In step S11, the invisible component removal unit 342 generates a second visible image in which an invisible component is removed.

Then, in step S12, the necessity determination unit 343 determines whether an invisible component is to be removed from the first invisible image. For example, when the object P is a monochrome document, it is determined that an invisible component is not to be removed from the first invisible image. Based on a determination that an invisible component is to be removed, i.e., the removal is to be performed (YES in step S13), the output unit 344 outputs the second visible image as an output image in Step S14. Based on a determination that an invisible component is not to be removed, i.e., the removal is not to be performed (NO in step S13), the output unit 344 outputs the first visible image as an output image in step S15.

As described above, according to the present embodiment, the processor 340 (i.e., circuitry) determines whether an invisible component is to be removed from the first image. Based on a determination that the removal is to be performed, the processor 340 outputs the second visible image in which the invisible component is removed. Based on a determination that the removal is not to be performed, the processor 340 outputs the first visible image in which the invisible component is not removed. This configuration prevents degradation in image quality caused by noise included in an invisible image.

The second sensor 322 may be an infrared image sensor having sensitivity to light in the infrared wavelength region. In this case, the invisible image input to the input unit 341 is an infrared image. The invisible component removal unit 342 calculates the second visible image in which an infrared component is removed from the first visible image. For the infrared image sensor, a typical image sensor using silicon as a base material, which is similar to the first sensor 321, may be used, except that it does not include a color filter. Thus, when an infrared image sensor is used as the second sensor 322, the configuration of the present embodiment can be manufactured at low cost.

In the above description, the processor 340 is placed on the photodetector substrate 120. However, the processor 340 may be placed outside the photodetector substrate 120. For example, the processor 340 may be mounted on the image processing board 230. The circuit scale of the image processing board 230 is typically larger than that of the photodetector substrate 120, and is designed with sufficient margin. Accordingly, the processor 340 can be mounted without increasing the circuit scale of the image processing board 230.

### Second Embodiment

In the second embodiment, whether an invisible component is to be removed from the first visible image is determined using an image reading mode. In the following description of the second embodiment, the description of portions that are the same as those in the first embodiment is omitted, and the differences from the first embodiment are described.

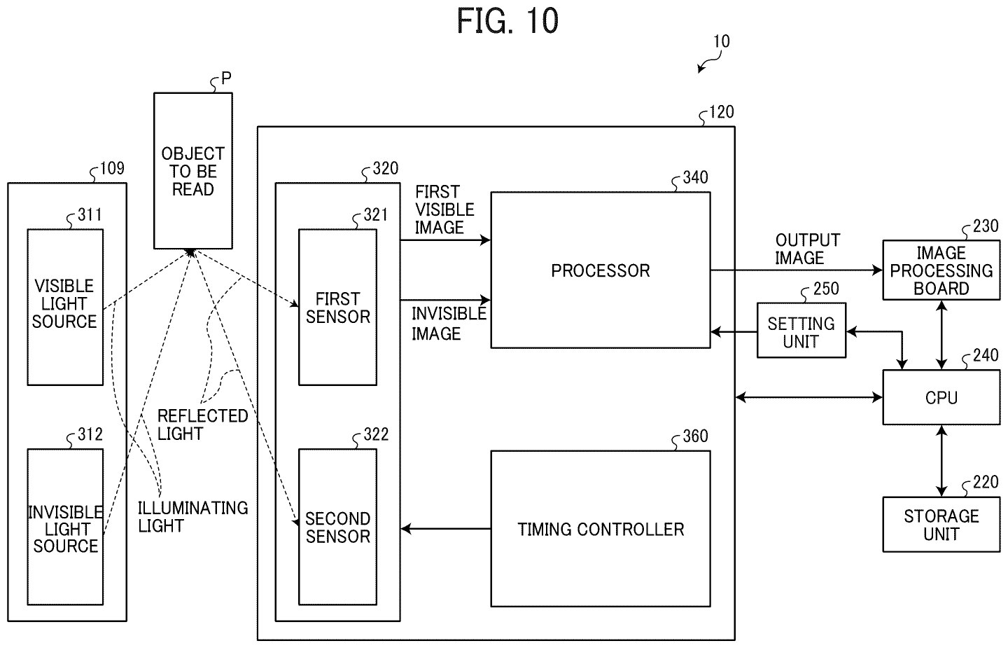

FIG. 10 is a block diagram of the configuration of an image reading device 10 according to the second embodiment. The difference from the first embodiment is that the image reading device 10 further includes a setting unit 250, and an image reading mode is input from the setting unit 250 to a processor 340. The setting unit 250 is included in an operation panel, and sets an image reading mode in accordance with an operation by a user.

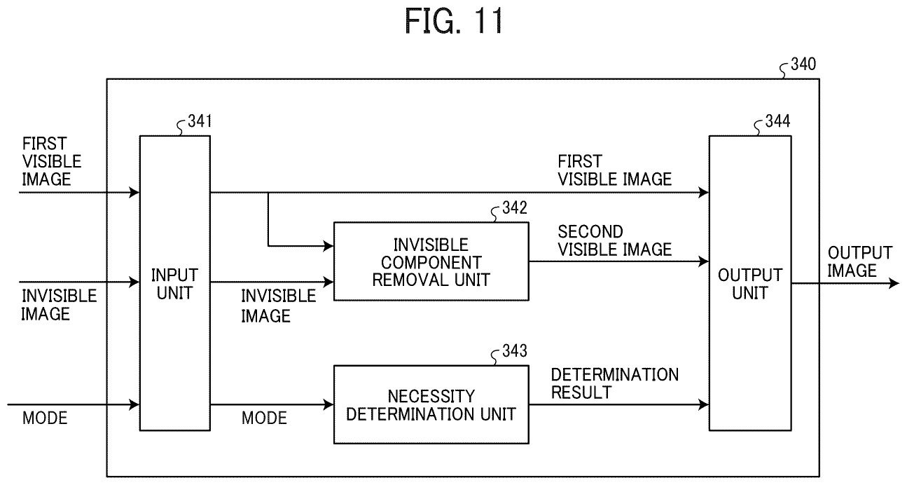

FIG. 11 is a block diagram of a functional configuration of the processor 340 included in the image reading device 10 according to the present embodiment. The difference from the first embodiment is that the image reading mode set by the setting unit 250 is input to the input unit 341, and that the necessity determination unit 343 determines uses the input mode to determine whether an invisible component is to be removed from the first visible image.

For example, when the image reading mode is a monochrome mode, the necessity determination unit 343 determines that an invisible component is not to be removed from the first visible image. A method for determining whether an invisible component is to be removed may be different from this. For example, it may be determined that an invisible component is not to be removed when a mode that does not involve color reproducibility, such as a mode of reading with two values of black and white or a mode of reading with a low resolution, is set.

In the present embodiment, as described above, it is determined whether an invisible component is to be removed using the image reading mode. This configuration prevents deterioration in image quality due to noise included in the invisible image, without using a complicated configuration for the processing to determine whether the invisible component is to be removed.

### Third Embodiment

In the third embodiment, the first visible image is used to determine whether an invisible component is to be removed. In the following description of the third embodiment, the description of portions that are the same as those in the first embodiment is omitted, and the differences from the first embodiment are described.

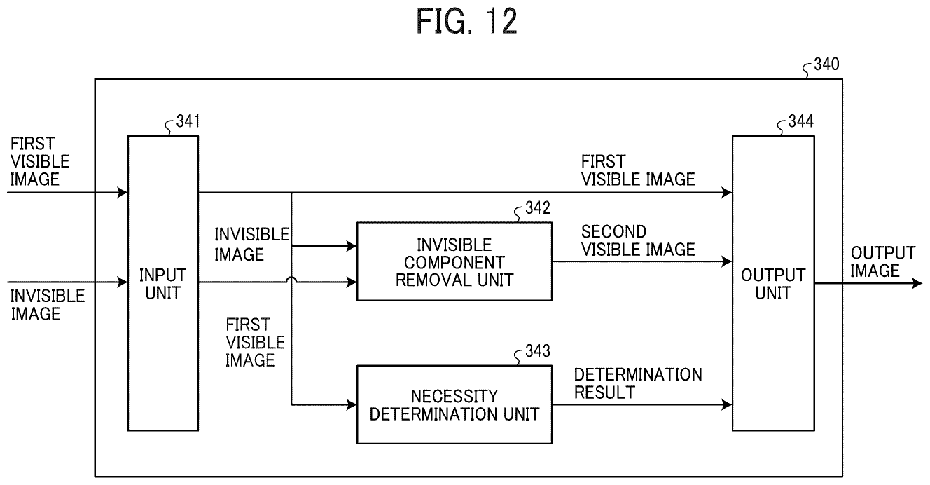

FIG. 12 is a block diagram of a functional configuration of a processor 340 included in an image reading device 10 according to the third embodiment. The difference from the first embodiment is that the first visible image is input to the necessity determination unit 343, and the necessity determination unit 343 determines whether an invisible component is to be removed from the first visible image based on the first visible image.

When the first visible image includes three images: an R image, a G image, and a B image captured by R, G, and B sensors, the necessity determination unit 343 performs the necessity determination (i.e., determination of whether an invisible component is to be removed from the first visible image) using a difference between the images. More specifically, absolute values of differences |R−G|, |G−B|, and |B−R| between the images are obtained for the same pixel in each of the R image, the G image, and the B image. When any of the absolute values is equal to or greater than a threshold value T, the necessity determination unit 343 determines that color reproducibility is involved, and further determines that an invisible component is to be removed. In other cases, i.e., when all of the absolute values are less than the threshold value T, the necessity determination unit 343 determines that color reproducibility is not involved, and further determines that the invisible component is not to be removed. The threshold value T is, for example, a value set in advance by experiments at a production facility. One threshold value may be set for differences between the R image, the G image, and the B image, or different values may be set for different differences.

The absolute values of the above differences may be calculated for each pixel, or may be calculated for each block by obtaining an average of pixel values in each block obtained by dividing an image. When the absolute values of the differences are calculated for each pixel, it is determined that an invisible component is to be removed, based on a determination that color reproducibility is involved in at least one pixel, or in at least predetermined number of pixels. When the absolute values of the differences are calculated for each block, it is determined that an invisible component is to be removed, based on a determination that color reproducibility is involved in at least one block, or in at least predetermined number of blocks. The three color sensors are an example of multiple color sensors having sensitivity to light in different visible wavelength ranges, and the number of colors used for the necessity determination (i.e., determination of whether an invisible component is to be removed from the first visible image) may be two, four, or more.

According to the present embodiment, by automatically determining whether an invisible component is to be removed using the first visible image, image quality degradation due to noise contained in the invisible image can be prevented.

### Fourth Embodiment

In the fourth embodiment, the second visible image is used to determine whether an invisible component is to be removed. In the following description of the fourth embodiment, the description of portions that are the same as those in the third embodiment is omitted, and the differences from the third embodiment are described.

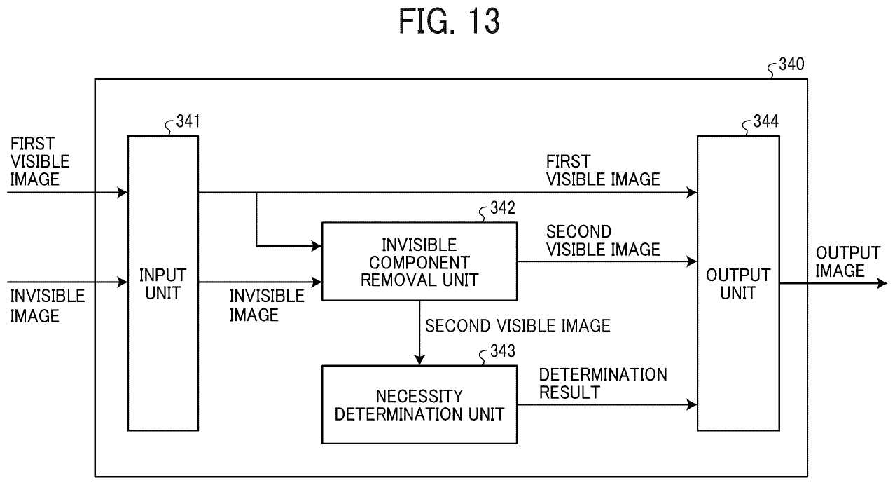

FIG. 13 is a block diagram of a functional configuration of a processor 340 included in an image reading device 10 according to the fourth embodiment. The difference from the third embodiment is that the second visible image is input to the necessity determination unit 343, and the necessity determination unit 343 determines whether an invisible component is to be removed from the first visible image based on the second visible image.

When the second visible image includes three images: an R image, a G image, and a B image captured by R, G, and B sensors, in which an invisible component is removed, the necessity determination unit 343 performs the necessity determination (i.e., determination of whether an invisible component is to be removed from the first visible image) using a difference between the images.

The second visible image, from which the invisible component has been removed, is an image in which granular noise is more conspicuous than in the first visible image, but this noise can be alleviated by smoothing processing. The smoothing processing does not influence the saturation. Accordingly, the second visible image after the smoothing processing may be used to determine whether an invisible component is to be removed, as in the third embodiment.

The output unit 344 stores the first visible image and the second visible image in the storage unit 220, and outputs either one of the images as an output image based on the determination result of the necessity determination unit 343. The first visible image and the second visible image may be stored in a memory other than the storage unit 220. The memory is, for example, a memory included in the processor 340.

According to the present embodiment, by automatically determining whether an invisible component is to be removed using the second visible image, image quality degradation due to noise contained in the invisible image can be prevented. Since the invisible component is removed from the second visible image, the color of the second visible image is closer to the color of the object P, allowing more accurate determination of whether color reproducibility is involved.

### Fifth Embodiment

In the fifth embodiment, the speed at which the object P is read is changed based on the determination result of the necessity determination unit 343. In the following description of the fifth embodiment, the description of portions that are the same as those in the first embodiment is omitted, and the differences from the first embodiment are described.

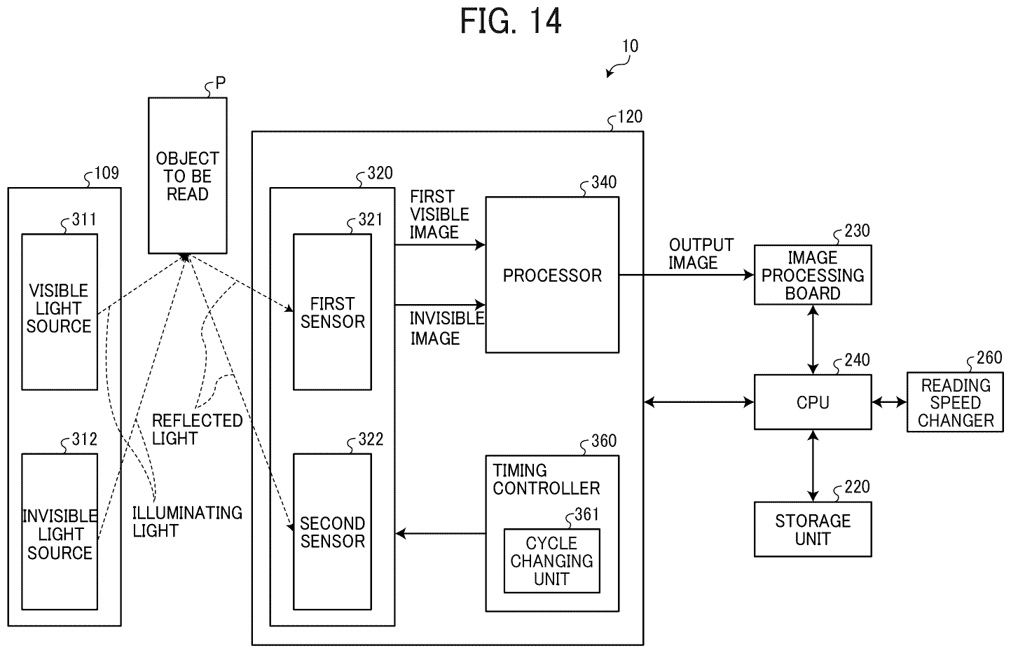

FIG. 14 is a block diagram of the configuration of an image reading device 10 according to the fifth embodiment. The difference from the first embodiment is that the image reading device 10 includes a cycle changing unit 361 in the timing controller 360, and a reading speed changer 260.

The cycle changing unit 361 changes the drive cycle of the photodetector substrate 120 based on the determination result of the necessity determination unit 343. The reading speed changer 260 changes the reading speed of the object to be read according to the drive cycle changed by the cycle changing unit 361. Specifically, the reading speed changer 260 changes the conveyance speed of the document by the ADF 102 during the sheet-through reading, and changes the scanning speed of the carriage during the flatbed reading.

Since the first visible image contains less noise than the second visible image from which the invisible component is removed, the first visible image has a certain margin against noise generated by reducing the amount of light per unit time incident on the sensor 320. When the processor 340 outputs the first visible image, a decrease in the amount of light corresponding to the margin is allowed. That is, when the processor 340 outputs the first visible image, the amount of light can be reduced by shortening the drive cycle of the photodetector substrate 120, and the reading speed of the object P can be increased by the amount corresponding to the shortening of the drive cycle.

In the above description, the case in which the first embodiment is applied is described. In some embodiments, any of the second embodiment to the fourth embodiment is applicable. In this case, the difference from the second to fourth embodiments is that the image reading device 10 further includes the reading speed changer 260, and the cycle changing unit 361 in the timing controller 360 (or a timing circuitry), as in the first embodiment. Further, it may be set in advance whether priority is given to the reading speed or to the image quality of the read image.

For example, when the threshold value T used in the third or fourth embodiment is set to a greater value, it is likely to be determined that the invisible component is not to be removed, and the reading speed is prioritized. The reading speed may be increased by a predetermined amount or may be set by the operation unit each time.

According to the present embodiment, whether the invisible component is to be removed can be determined, and image quality degradation due to noise contained in the invisible image can be prevented. Further, when it is determined that the invisible component is to be removed, the reading speed may be increased to enhance the productivity of the image reading device 10.

### Sixth Embodiment

In the sixth embodiment, the configuration of the image reading device 10 according to any one of the first to the fifth embodiment is incorporated in an image forming apparatus. In the following description of the sixth embodiment, the description of portions that are the same as those in the first embodiment to the fifth embodiment is omitted, and the differences from the first embodiment to the fifth embodiment are described.

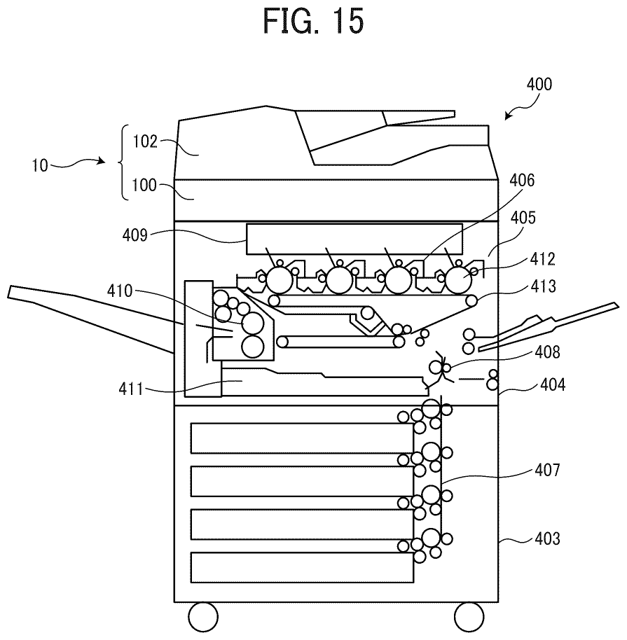

FIG. 15 is a cross-sectional view illustrating the configuration of a mechanical section of an image forming apparatus 400 according to the present embodiment. The image forming apparatus 400 (for example, a digital copying machine) includes the image reading device 10, a sheet feeder 403, and an image forming apparatus body 404. The image reading device 10 includes a reading unit body 100 and an ADF 102, and has the same configuration as in the first to fifth embodiments.

The image forming apparatus body 404 includes a tandem image forming unit 405, a registration roller pair 408 that conveys a recording sheet (or a recording medium) supplied from the sheet feeder 403 through a conveyance path 407, an optical writing device 409, a fixing and conveyance device 410 and a duplex tray 411. The image forming apparatus body 404 is an example of an image former.

In the image forming unit 405, four photoconductor drums 412 are arranged in parallel, corresponding to the four colors of yellow (Y), magenta (M), cyan (C), and black (K). Further, image forming elements including a charger, a developing device 406, a transfer device, a cleaner, and a static eliminator are arranged around a corresponding one of the photoconductor drums 412. Additionally, the intermediate transfer belt 413 is stretched over a driving roller and a driven roller, such that the intermediate transfer belt 413 is sandwiched between the transfer devices and the photoconductor drums 412 to form nips therebetween.

Such an image forming apparatus 400, which has a tandem-type configuration as described above, performs optical writing of an image. More specifically, the image forming apparatus 400 optically writes the image of each color, that is, yellow (Y), magenta (M), cyan (C), and black (K), on a corresponding one of the photoconductor drums 412 to form a latent image. Each latent image is developed into a toner image with toner at a corresponding one of the developing devices 406. The toner images are then sequentially subjected to a primary transfer, in the order of Y, M, C, and K, onto the intermediate transfer belt 413, to form a full-color image in which the toner images are superimposed one above another. The full color image, in which four color images are superimposed by primary transfer, is transferred onto the recording sheet through a secondary transfer, and fixed on the recording sheet. Then, the recording sheet on which the image is fixed is ejected.

According to the present embodiment, by incorporating the image reading device 10 according to any one of the first embodiment to the fifth embodiment determines into an image forming apparatus 400, such an image forming apparatus 400 determines whether an invisible component is to be removed, and prevents image quality degradation caused by noise contained in the invisible image.

FIG. 15 illustrates the image forming apparatus 400 having an electrophotographic image forming mechanism. In some examples, the image forming apparatus 400 may include another image forming mechanism such as an inkjet image forming mechanism.

### Seventh Embodiment

In the seventh embodiment, the configuration of the image reading device 10 according to any one of the first to the fifth embodiment is incorporated in a biological imaging apparatus.

Image acquisition using infrared light may be used for biological imaging in a biological imaging apparatus. This is because light in the near-infrared wavelength region is less absorbed by the components of biological tissue, resulting in high tissue transmittance. One application example of biological imaging using the biological imaging apparatus involves imaging in combination with a pigment that absorbs near-infrared light.

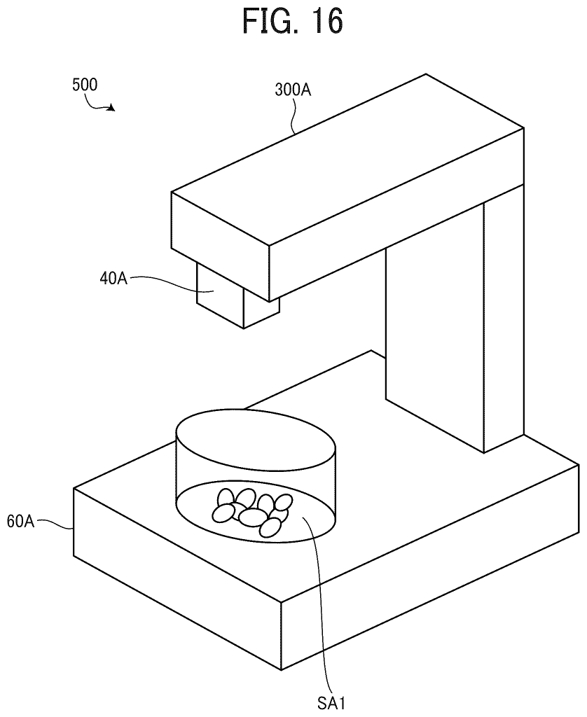

FIG. 16 is a diagram of a configuration of a biological imaging apparatus according to a seventh embodiment. A biological imaging apparatus 500 includes an imager 40A, a controller 300A (i.e., the image processing device), and a sample table 60A. Based on cell images captured by the imager 40A, the biological imaging apparatus 500 generates an image that allows specific cells and other cells to be easily observed at the same time based on images of cells acquired by the imager 40A.

In FIG. 16, a sample SAI enclosed in a vessel is placed on a sample table 60A that holds a subject (e.g., an object P) at a desired position. The imager 40A includes a first sensor 321 and a second sensor 322. The first sensor 321 and the second sensor 322 are, for example, CMOS image sensors. The imager 40A acquires a first visible image obtained by the first sensor 321 imaging multiple types of cells contained in the sample SAI. The imager 40A acquires an invisible image of the same subject captured by the second sensor 322, and determines the positions of specific cells contained in the sample SAI using a method to be described later. The second sensor 322 captures an image with near-infrared light to acquire a near-infrared image, for example.

The controller 300A includes a CPU and a memory, and implements the function of determining whether the invisible component is to be removed, and removing the invisible component from the visible image, similarly to the processor 340 in the first to fifth embodiments.

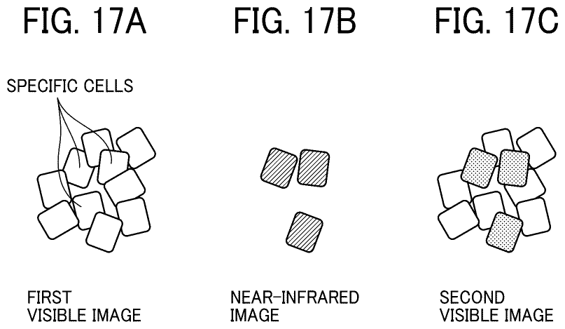

FIGS. 17A, 17B, and 17C are diagrams illustrating application examples of biological imaging according to the present embodiment. FIG. 17A illustrates a first visible image of a group of multiple types of cells acquired by the first sensor 321. As illustrated in FIG. 17A, the colors of the cells are similar in the first visible image, and specific cells cannot be identified. In such a case, for the purpose of observing a specific cell, near-infrared imaging may be performed using a near-infrared absorbing dye that stains only the specific cells, enabling cell imaging with higher sensitivity than visible imaging.

FIG. 17B illustrates a near-infrared image obtained by the second sensor 322 from a group of multiple types of cells in such cellular imaging. As illustrated in FIG. 17B, specific cells that have reacted to the near-infrared light can be confirmed. However, other cells cannot be confirmed by the near-infrared image alone, because the near-infrared light is transmitted through the other cells.

In the present embodiment, the invisible component removal unit 342 generates the second visible image by, for example, subtracting data obtained by inverting the data of the invisible image (e.g., a near-infrared image) from the first visible image. For example, when the image data is 8-bit data having values from 0 (minimum brightness) to 255 (maximum brightness), data E obtained by inverting the data D of the near-infrared image is calculated by the following Expression (1).

E=255−D (1)

FIG. 17C illustrates a second visible image calculated from the first visible image and the near-infrared image. As illustrated in FIG. 17C, the specific cells that have reacted to the near-infrared light can be distinguished from the other cells by the processing of the invisible component removal unit 342. The second visible image includes overall noise because the noise of the near-infrared image is superimposed. Thus, the first visible image illustrated in FIG. 17A is used for observing the entire group of cells, and the output image is switched to the second visible image when the above-described specific cells are observed. In the present embodiment, an image suitable for the intended purpose can be obtained.

As described above, according to one aspect of the present disclosure, the biological imaging apparatus 500 incorporating the image reading device 10 according to any one of the first embodiment to the fifth embodiment can be provided. This biological imaging apparatus 500 performs near-infrared imaging by switching between the first visible image and the second visible image according to the intended purpose.

Although some embodiments of the present disclosure have been described above, the above-described embodiments are presented as examples and are not intended to limit the scope of the present invention. The new embodiments may be implemented in a variety of other forms; furthermore, various omissions, substitutions, and changes in the forms may be made without departing from the gist and scope of the disclosure. In addition, the embodiments and modifications or variations thereof are included in the scope and the gist of the invention, and are included in the invention described in the claims and the equivalent scopes thereof. Further, elements according to varying embodiments or modifications may be combined as appropriate.

Each of the functions of the described embodiments can be implemented by one or more processing circuits or circuitry. Processing circuitry includes a programmed processor, as a processor includes circuitry. A processing circuit also includes devices such as an application-specific integrated circuit (ASIC), a digital signal processor (DSP), a field-programmable gate array (FPGA), a system on a chip (SOC), a graphics processing unit (GPU), and conventional circuit components arranged to perform the recited functions.

Aspects of the present invention are as follows, for example.

### Aspect 1

An image processing device includes circuitry configured to receive a first visible and an invisible image, remove the invisible component from the first visible image based on the invisible image to generate a second visible image, determine whether to remove the invisible component from the first visible image, and output either the first visible image based on a determination not to remove the invisible component or output the second visible image based on a determination to remove the invisible component. The first visible image is captured by a first sensor having a first sensitivity to both of first light in a visible wavelength range; and second light in an invisible wavelength range. The first light and the second light are reflected from an object to be read, and the first visible image includes an invisible component in the invisible wavelength range. The invisible image is captured by a second sensor having a second sensitivity to the second light.

### Aspect 2

In the image processing device according to Aspect 1, the circuitry is further configured to receive an image reading mode; and determine whether to remove the invisible component from the first visible image based on the image reading mode.

### Aspect 3

In the image processing device according to Aspect 2, the circuitry determines not to remove the invisible component from the first visible image in response to a setting of the image reading mode to a monochrome mode.

### Aspect 4

In the image processing device according to Aspect 1, the circuitry determines whether to remove the invisible component from the first visible image based on the first visible image.

### Aspect 5

In the image processing device according to Aspect 1 or 4, the circuitry is further configured to receive the first visible image including multiple images captured with light in mutually different visible wavelength ranges; obtain a difference between the multiple images; and determine whether to remove the invisible component from the first visible image based on the difference obtained.

### Aspect 6

In the image processing device according to Aspect 1, the circuitry determines whether to remove the invisible component from the first visible image based on the second visible image.

### Aspect 7

In the image processing device according to Aspect 1 or 6, the circuitry is further configured to receive the second visible image including multiple images captured with light in mutually different visible wavelength ranges, obtain a difference|between the multiple images; and determine whether to remove the invisible component from the first visible image based on the difference obtained.

### Aspect 8

An image reading device includes the image processing device according to any one of Aspects 1 to 7; a first sensor having a first sensitivity to both of first light, reflected from the object, in a visible wavelength range; and second light, reflected from the object, in an invisible wavelength range; and a second sensor having a second sensitivity to the second light in the invisible wavelength range.

### Aspect 9

The image reading device according to Aspect 8, further includes a reading speed changer to change a reading speed for reading the object based on the determination from the image processing device; and timing circuitry configured to change a drive cycle of the first sensor and the second sensor based on the determination from the image processing device.

### Aspect 10

In the image reading device according to Aspect 8 or 9, the second light in the invisible wavelength range is infrared light.

### Aspect 11

An image forming apparatus incudes the image reading device according to any one of Aspects 8 to 10; and an image former to form an image based on an output data from the image reading device.

### Aspect 12

A biological imaging apparatus includes the image processing device according to any one of Aspects 1 to 7; and an imager including a first sensor and a second sensor. The first sensor has a first sensitivity to both of a first light, reflected from the object, in a visible wavelength range and the second light, reflected from the object, in an invisible wavelength range, to capture a first visible image. The second sensor has a second sensitivity to the second light in the invisible wavelength range, to capture the invisible image. The circuitry determines whether to remove the invisible component from the first visible image.

### Aspect 13

An image processing method includes receiving: a first visible image captured by a first sensor and an invisible image. The first visible image is captured by a first sensor having a first sensitivity to both of first light in a visible wavelength range; and second light in an invisible wavelength range. The first light and the second light are reflected from an object to be read, and the first visible image includes an invisible component in the invisible wavelength range. The invisible image is captured by a second sensor having a second sensitivity to the second light. The image processing method further includes removing the invisible component from the first visible image based on the invisible image to generate a second visible image; determining whether to remove the invisible component from the first visible image; and outputting either the first visible image based on a determination not to remove the invisible component; or outputting the second visible image based on a determination to remove the invisible component.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image processing device comprising circuitry configured to:
receive:
a first visible image captured by a first sensor having a first sensitivity to both of:
first light in a visible wavelength range; and
second light in an invisible wavelength range,
the first light and the second light being reflected from an object to be read, and
the first visible image including an invisible component in the invisible wavelength range; and
an invisible image captured by a second sensor having a second sensitivity to the second light,
remove the invisible component from the first visible image based on the invisible image to generate a second visible image;
determine whether to remove the invisible component from the first visible image; and
output either:
the first visible image based on a determination not to remove the invisible component; or
the second visible image based on a determination to remove the invisible component.

2. The image processing device according to claim 1,
wherein the circuitry is further configured to:
receive an image reading mode; and
determine whether to remove the invisible component from the first visible image based on the image reading mode.

3. The image processing device according to claim 2,
wherein the circuitry determines not to remove the invisible component from the first visible image in response to a setting of the image reading mode to a monochrome mode.

4. The image processing device according to claim 1,
wherein the circuitry determines whether to remove the invisible component from the first visible image based on the first visible image.

5. The image processing device according to claim 1,
wherein the circuitry is further configured to:
receive the first visible image including multiple images captured with light in mutually different visible wavelength ranges;
obtain a difference between the multiple images; and
determine whether to remove the invisible component from the first visible image based on the difference obtained.

6. The image processing device according to claim 1,
wherein the circuitry determines whether to remove the invisible component from the first visible image based on the second visible image.

7. The image processing device according to claim 1,
wherein the circuitry is further configured to:
receive the second visible image including multiple images captured with light in mutually different visible wavelength ranges,
obtain a difference|between the multiple images; and
determine whether to remove the invisible component from the first visible image based on the difference obtained.

8. An image reading device comprising:
the image processing device according to claim 1;
a first sensor having a first sensitivity to both of:
first light, reflected from the object, in a visible wavelength range; and
second light, reflected from the object, in an invisible wavelength range; and
a second sensor having a second sensitivity to the second light in the invisible wavelength range.

9. The image reading device according to claim 8, further comprising:
a reading speed changer to change a reading speed for reading the object based on the determination from the image processing device; and
timing circuitry configured to change a drive cycle of the first sensor and the second sensor based on the determination from the image processing device.

10. The image reading device according to claim 8,
wherein the second light in the invisible wavelength range is infrared light.

11. An image forming apparatus comprising:
the image reading device according to claim 8; and
an image former to form an image based on an output data from the image reading device.

12. A biological imaging apparatus comprising:
the image processing device according to claim 1; and
an imager including:
a first sensor having a first sensitivity to both of:
a first light, reflected from the object, in a visible wavelength range and;
a second light, reflected from the object, in an invisible wavelength range, to capture a first visible image; and
a second sensor having a second sensitivity to the second light in the invisible wavelength range, to capture the invisible image,
wherein the circuitry determines whether to remove the invisible component from the first visible image.

13. An image processing method comprising:
receiving:
a first visible image captured by a first sensor having a first sensitivity to both of:
first light in a visible wavelength range; and
second light in an invisible wavelength range,
the first light and the second light being reflected from an object to be read, and
the first visible image including an invisible component in the invisible wavelength range; and
an invisible image captured by a second sensor having a second sensitivity to the second light,
removing the invisible component from the first visible image based on the invisible image to generate a second visible image;
determining whether to remove the invisible component from the first visible image; and
outputting either:
the first visible image based on a determination not to the determination result to remove the invisible component; or
the second visible image based on a determination to remove the invisible component.
